(19) United States
(12) Patent Application Publication
(10) Pub. No.: US 2013/0307243 A1
(43) Pub. Date: Nov. 21, 2013

(54) SUSPENSION ARM DEVICE FOR VEHICLE

(71) Applicant: HYUNDAI MOTOR COMPANY, Seoul (KR)

(72) Inventor: Hyeong Seung Ham, Anyang-si (KR)

(73) Assignee: Hyundai Motor Company, Seoul (KR)

(21) Appl. No.: 13/650,780

(22) Filed: Oct. 12, 2012

(30) Foreign Application Priority Data
May 15, 2012 (KR) 10-2012-0051293

(51) Int. Cl. B60G 3/06

(52) U.S. Cl. 280/124.134

(57) ABSTRACT

A suspension arm jointing device for a vehicle includes a steering axis and a roll center can be independently controlled. By dualizing a joint between a lower arm and a knuckle into a rotation portion based on wheel steering and a rotation portion based on wheel's up/down movement, a lower aim joint's function for determining a roll center height during turning and determination of an steering axis position which affects wheel vibration and braking stability during linear driving can be controlled independently of each other, thereby heightening the roll center and determining an optimal steering axis (kingpin axis) position.

### CROSS-REFERENCE TO RELATED APPLICATION

The present application claims priority of Korean Patent Application Number 10-2012-0051293 filed May 15, 2012, the entire contents of which application is incorporated herein for all purposes by this reference.

### BACKGROUND OF INVENTION

1. Field of Invention

The present invention relates to a suspension arm device for a vehicle. More particularly, the present invention relates to a suspension arm joining device for a vehicle, in which a steering axis and a roll center can be independently controlled.

2. Description of Related Art

A suspension device for a vehicle refers to a device which absorbs a shock delivered to a vehicle body due to an uneven pavement surface and improves ride comfort by adjusting movement of the vehicle body during driving, braking, and turning of the vehicle.

As shown in FIG. 1, the suspension device includes a strut 10 which is a combination of a shock absorber, a spring, a bump stopper, and an insulator to provide a buffer capacity with upward and downward forces applied thereto, a lower arm 12 which delivers a load introduced from a wheel 24 to a subframe 26 and controls wheel's movement to a desired position, a knuckle 14 connected between the strut 10 and the lower arm 12 to support wheel's rotation with loads applied thereto from front/rear/left/right sides of the vehicle, and a ball joint 16 connected between an outer end of the lower arm 12 and a lower end portion of the knuckle 14 to function as a wheel's steering axis.

A roll center height of the suspension device is an important performance factor for securing vehicle turning stability, and a roll center height determining principle will be described below with reference to FIG. 2.

For reference, the roll center means a center position at which a vehicle is tilted or is shaken when turning, for example, on an uneven section.

The outer end of the lower arm 12 and the lower end of the knuckle 14 are connected to each other by the ball joint 16 functioning as the wheel's steering axis, and a lower end of the strut 10 is mounted on an upper end of the knuckle 14.

Based on such a structure, as shown in FIG. 2, when a perpendicular line a extending from a mounting center of the strut 10 in perpendicular to a steering axial line A, which is a steering axis (kingpin axis), and a lower arm extension line b linearly extending inwardly with respect to the vehicle body from a lower arm rotation axis 18 connected with the lower arm ball joint 16 via the subframe meet each other to form a first intersection c, a connection line e connecting the first intersection c and a tire ground contact point d and a vehicle center line f meet each other to form a second intersection g which is a roll center, and a height from the second intersection g, the roll center, to the ground is determined as the roll center height.

The determined roll center height is an important performance factor for vehicle turning stability, and as the length of a moment arm, i, which is a distance from the second intersection g, the roll center, to a vehicle's weight center h, is shorter, the moment which urges the vehicle, while turning, to be tilted is smaller, thus suppressing roll.

The roll center height may be increased or reduced according to a position of the lower arm ball joint 16.

As shown in FIG. 3, if the position of the lower arm ball joint 16 is lowered, a gradient of a lower arm extension line b′ is increased, a first intersection c′ moves toward the vehicle center line, and a second intersection g′ at which a connection line e′ connecting the first intersection c′ and the tire ground contact point d meets the vehicle center line f is also heightened, so that the roll center height corresponding to a height from the second height g′ to the ground is also increased.

As such, if the roll center height is increased, the moment arm's length i, which is the distance from the second intersection g′, the roll center, to the vehicle weight center h, is reduced, so that the moment which urges the vehicle, while turning, to be tilted is reduced and thus roll can be easily suppressed.

However, if the position of the lower arm ball joint is lowered, the following problems occur.

If the lower arm ball joint 16 is lowered to suppress roll in vehicle's turning, the steering axial line A moves toward the inner side of the vehicle as shown in FIG. 4, to form another steering axial line A′, and a point B′ at which the steering axial line A′ meets the ground moves toward the center of the vehicle with respect to a point B at which the original steering axial line A meets the ground.

If so, a ground kingpin offset D, which is a distance between the point B′ at which the steering axial line A′ meets the ground and a tire ground contact point C, is reduced or if a distance reduction increases, the point B′ at which the steering axial line A′ meets the ground is positioned in the inner side of the vehicle with respect to the tire ground contact point C.

Based on the steering axial line A′ moved to the inner side of the vehicle, a wheel center kingpin offset E is also increased, and when the wheel center kingpin offset E is increased or the ground kingpin offset D is reduced, handle vibration during driving or braking stability is degraded.

To solve this problem, the lower arm ball joint has to be moved to the outside of the vehicle, but due to a space restriction with a brake disk, there is also a restriction in movement of the ball joint to the outside of the vehicle, so that neither roll center securing nor ground kingpin offset securing can be solved.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with prior art. Various aspects of the present invention provide for a suspension arm jointing device for a vehicle, in which a joint between a lower arm and a knuckle is dualized into a rotation portion based on wheel steering and a rotation portion based on wheel up/down movement so that a function of a lower arm joint which determines a roll center height during vehicle's turning and determination of a position of a steering axis which affects wheel vibration and braking stability during vehicle's linear driving can be controlled independently of each other, thereby heightening a roll center and determining an optimal steering axis (kingpin axis) position.

Various aspects of the present invention provide for a suspension arm jointing device for a vehicle, in which a lower arm and a knuckle of a suspension are connected by a control link in such a way that a lower end of the knuckle is connected to an upper end of the control link using a left/right rotation member in a way to rotate to the left and to the right and an outer end of the lower arm is connected to a lower end of the control link using up/down rotation members in a way to rotate up and down.

In particular, a knuckle connection rod may be formed on the upper end of the control link, and the up/down rotation members are configured on the lower end of the control link and the outer end of the lower arm.

The up/down rotation member according to various aspects of the present invention may include a pair of hinge ends formed integrally while forming a groove into which the outer end of the lower arm may be inserted on the lower end of the control link and a hinge rod mounted on the outer end of the lower arm to be hinge-coupled with the hinge ends.

The up/down rotation member according to various aspects of the present invention may include a pair of hinge ends formed integrally while forming a groove on the outer end of the lower arm and a hinge rod mounted on the lower end of the control link to be hinge-coupled with the hinge ends.

The left/right rotation member may be formed by forming an engagement end having an engagement hole integrally on the lower end of the knuckle and burying in the engagement hole a bearing into which the knuckle connection rod of the control link is inserted in a way to rotate.

A nut may be engaged with or press-fitted into an upper end of the knuckle connection rod of the control link, the upper end passing through the bearing and protruding from the engagement hole of the engagement end.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram for describing a structure of a vehicle suspension.

FIG. 2 is a schematic diagram for describing a roll center height determination principle of a vehicle suspension.

FIG. 3 is a schematic diagram for describing that a roll center height changes according to a position of a lower arm ball joint of a vehicle suspension.

FIG. 4 is a schematic diagram for describing steering axis change when a position of a lower arm ball joint of a vehicle suspension is lowered.

FIGS. 5 and 6 are exploded perspective views for describing a structure of an exemplary suspension arm jointing device for a vehicle according to the present invention.

FIG. 7 is a cross-sectional view showing an assembled state of an exemplary suspension arm jointing device for a vehicle according to the present invention.

FIG. 8 is a cross-sectional view for describing an operating principle in wheel steering of an exemplary suspension arm jointing device for a vehicle according to the present invention.

FIG. 9 is a cross-sectional view for describing an operating principle in wheel bump and rebound of an exemplary suspension arm jointing device for a vehicle according to the present invention.

FIG. 10 is a schematic diagram for describing steering axis change in an exemplary suspension arm jointing device for a vehicle according to the present invention.

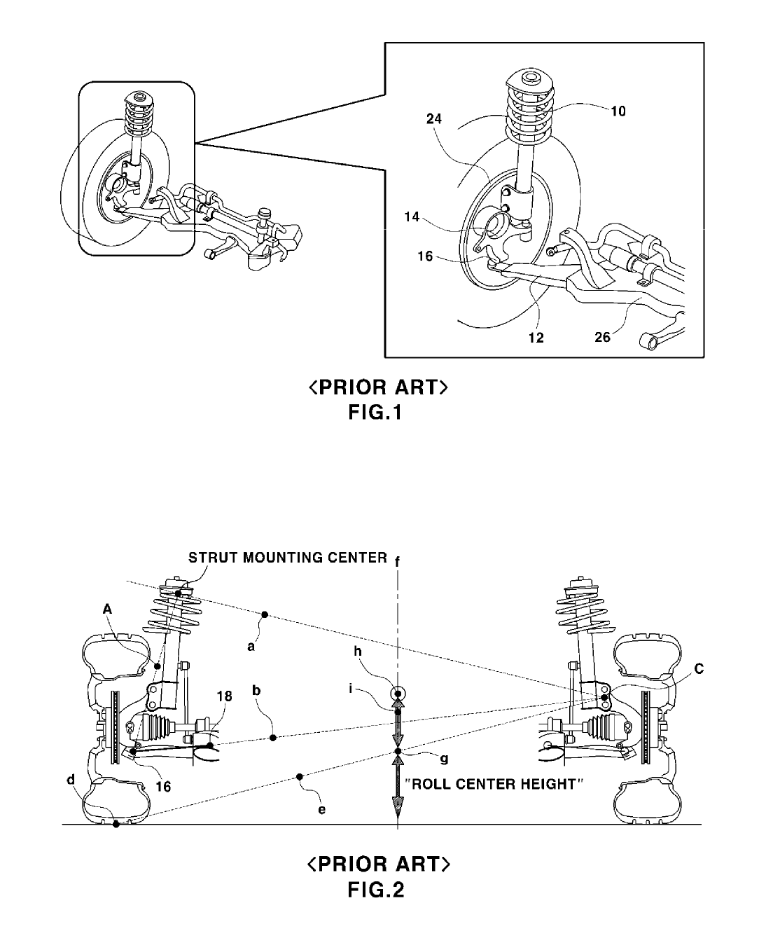

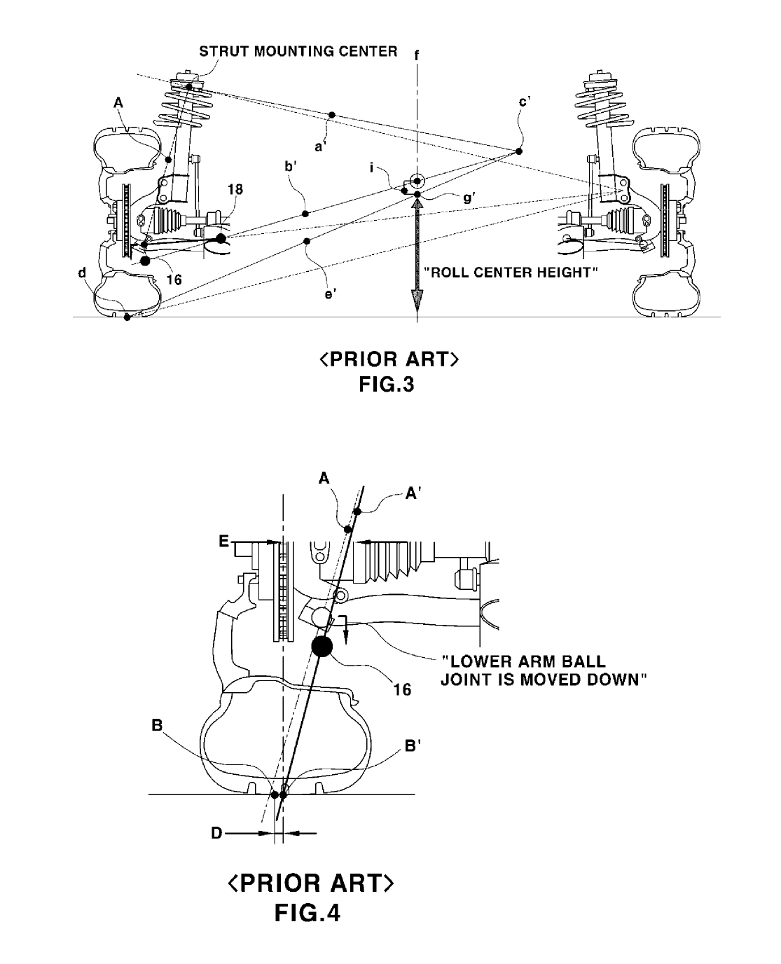

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As mentioned previously, conventionally, up/down rotation based on wheel's up/down movement and left/right rotation based on wheel steering are performed simultaneously by a lower arm ball joint connecting a knuckle and a lower arm, so that a roll center is heightened by lowering a position of the lower arm ball joint, causing many problems.

The present invention dualizes a joint portion between a lower arm and a knuckle into a left/right rotation portion based on wheel steering and a up/down rotation portion based on wheel up/down movement for independent control, thereby determining an optimal sheering axis (kingpin axis) position while heightening the roll center.

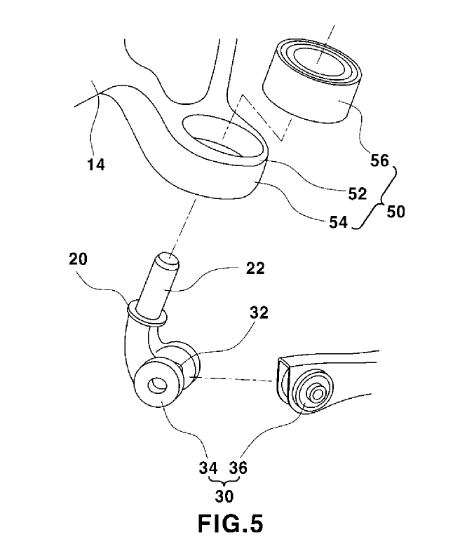

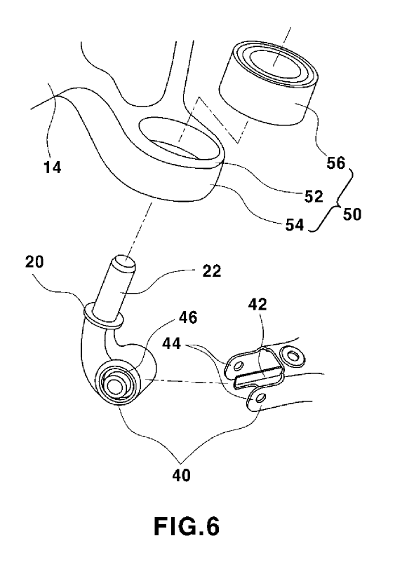

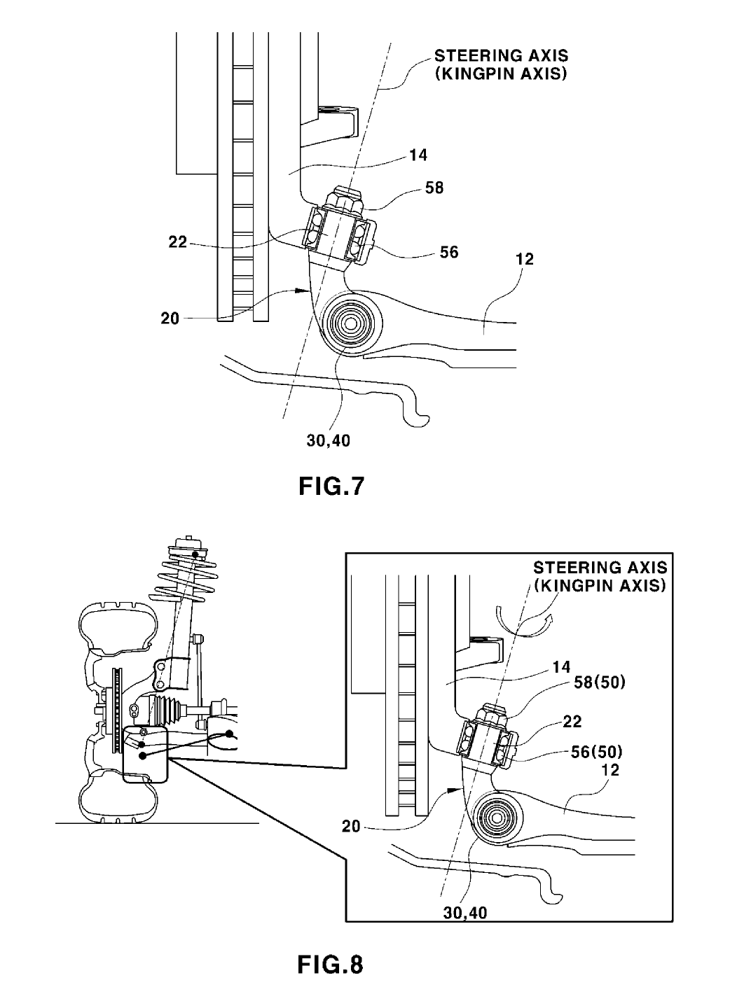

To this end, as shown in FIGS. 5 through 7, a lower arm 12 and a knuckle 14 of a suspension are connected by a control link 20 which allows left/right rotation based on wheel steering and up/down rotation based on wheel up/down movement to be controlled independently of each other.

That is, a lower end portion of the knuckle 14 is connected to an upper end of the control link 20 using a left/right rotation member 50 in such a way to rotate to the left and to the right, and an outer end of the lower arm 12 is connected to a lower end of the control line 20 using up/down rotation members 30 and 40 in such a way to rotate up and down.

On the upper end of the control link 20 is formed a knuckle connection rod 22 of a predetermined length, and on the lower end of the control link 20 bent inwardly are provided the outer end of the lower arm 12 and the up/down rotation members 30 and 40.

The up/down rotation member 30 according to various embodiments of the present invention includes a pair of hinge ends 34 formed integrally while forming a groove 32 into which the outer end of the lower arm 12 is inserted on the lower end of the control link 20, and a hinge rod 36 mounted on the outer end of the lower arm 12 to be hinge-coupled with the hinge ends 34.

The up/down rotation member 40 according to various embodiments includes a pair of hinge ends 44 formed integrally while forming a groove 42 on the outer end of the lower arm 23, and a hinge rod 46 mounted on the lower end of the control link 20 to be hinge-coupled to the hinge ends 44.

The left/right rotation member 50 is formed by forming an engagement end 54 having an engagement hole 52 integrally at a lower end of the knuckle 14 and burying a bearing 56 in the engagement hole 52, so that the knuckle connection rod 22 of the control link 20 is through-inserted into the bearing 56 in such a way to support rotation.

A screw thread is formed on an upper end of the knuckle connection rod 22 of the control link 20, which passes through the bearing 56 and protrudes from the engagement hole 52 of the engagement end 54, and a nut 58 may be engaged with the screw thread, or the knuckle connection rod 22 is forcedly press-fitted into the engagement hole 52, thus achieving mounting of the control link with respect to the knuckle arm.

Herein, the operating principle of the foregoing suspension arm jointing device for a vehicle will be described below.

### Operating Principle in Wheel Steering

As shown in FIG. 8, in wheel steering, a knuckle connected with a wheel rotates with respect to a steering axis, i.e., the left/right rotation member 50.

More specifically, the knuckle connection rod 22 of the control link 20 is inserted into the bearing 56 in the engagement end 54 of the knuckle 14, so that the knuckle 14 rotates while being rotation-supported by the bearing 56 and at the same time, an axle and a tire also rotate for steering, together with the knuckle 14.

A connection portion between the control link 20 and the lower arm 12, that is, a portion in which the outer end of the lower arm 12 and the lower end of the control link 20 are connected by the up/down rotation members 30 and 40, rotates up and down because a rotation center of the connection portion is set in a forward/backward direction, so that the connection portion does not rotate in a steering direction.

### Operating Principle in Wheel Pump and Rebound

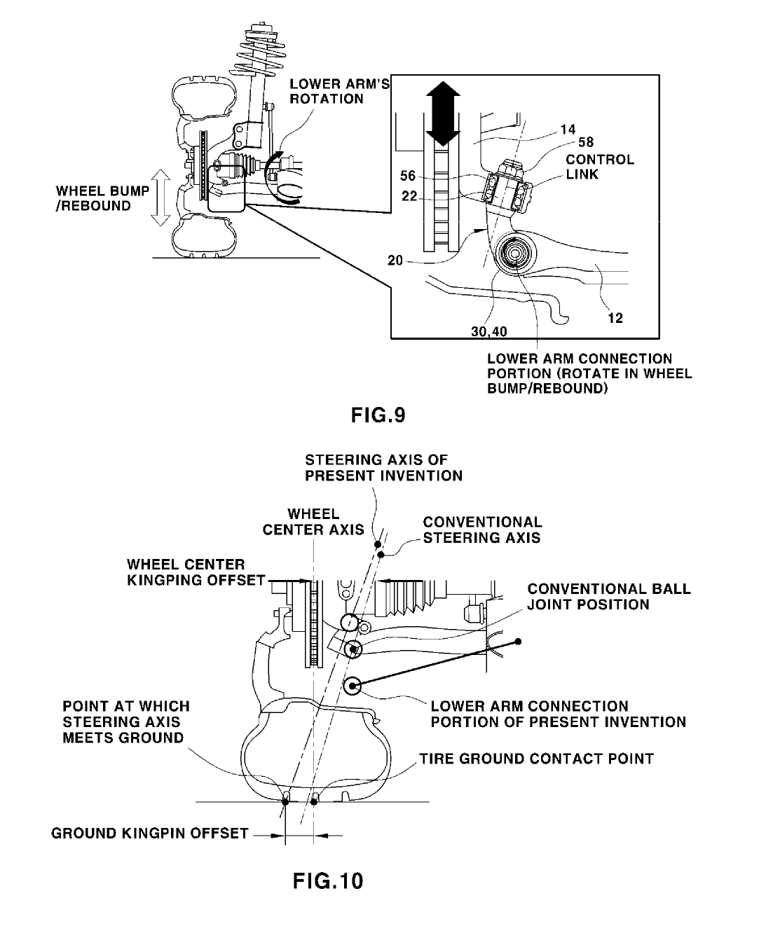

As shown in FIG. 9, in a pump or rebound operation of wheel and tires, the lower arm 12 rotates with respect to a subframe connection portion thereof.

That is, the lower arm 12 rotates up and down with respect to the up/down rotation members 30 and 40 which connect the lower end of the control line 20 and the outer end of the lower arm 12.

More specifically, with respect to a point at which the hinge ends 34 formed on the lower end of the control line 20 and the hinge rod 36 mounted on the outer end of the lower arm 12 in the up/down rotation member 30 according to various embodiments of the present invention are hinge-coupled to each other, the lower arm 12 rotates up and down.

Alternatively, with respect to a point at which the hinge ends 44 formed on the outer end of the lower arm 12 and the hinge rod 46 mounted on the lower end of the control link 20 in the up/down rotation member 40 according to various embodiments of the present invention are hinge-coupled to each other, the lower arm 12 rotates up and down.

### Steering Axis Change Principle

As can be seen in FIG. 10, when compared to a conventional steering axis going through the ball joint 16 connecting the knuckle 14 and the lower arm 12, a steering axis according to the present invention lowers a connection point with the lower arm 12 and is moved to the outside of the vehicle as the upper end of the control link 20 is connected to the knuckle 14 and the lower end of the control link 20 is connected to the lower arm 12 and the up/down rotation members 30 and 40.

As the steering axis is moved to the outside of the vehicle, the ground kingpin offset is increased and the wheel center kingpin offset is reduced, thereby reducing wheel vibration and improving braking stability during linear driving.

In addition, the connection portion between the control link and the lower arm is moved to a lower portion of the vehicle due to separation between steering rotation and function, so that the connection portion, even when moved to the inside of the vehicle, does not affect steering rotation regardless of a restriction such as a brake disk gap. Therefore, there is no restriction to the shape or size of the connection portion, and the lower arm may be mounted inclinedly to increase the roll center height, thereby improving turning stability through roll suppression in turning.

Based on the foregoing description, the present invention provides the following effects.

According to the present invention, on a joint portion between a lower arm and a knuckle is mounted a control rod for dualization into a left/right rotation portion based on wheel steering and an up/down rotation portion based on wheel's up/down movement, so that a lower arm joint's function for determining a roll center height during turning and determination of an steering axis position which affects wheel vibration and braking stability during linear driving can be controlled independently of each other.

In this way, as determination of the roll center height and determination of the steering axis position are controlled independently of each other, thereby moving the connection portion between the lower arm and the knuckle to a lower portion of the vehicle, and reducing a roll angle and improving turning stability during turning through increase in the roll center height.

Moreover, the steering axis can be moved to the outside of the vehicle, and wheel vibration reduction and braking stability can be secured during linear driving through wheel center offset reduction and ground kingpin offset increase.

For convenience in explanation and accurate definition in the appended claims, the terms upper or lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A suspension arm device for a vehicle, comprising:
a lower arm;
a suspension knuckle; and
a control link interconnecting the lower arm and the suspension knuckle;
wherein a lower end of the knuckle is connected to an upper end of the control link using a left/right rotation member to rotate to the left and to the right and an outer end of the lower arm is connected to a lower end of the control link using up/down rotation members to rotate up and down.

2. The suspension arm device of claim 1, wherein a knuckle connection rod is formed on the upper end of the control link, and the up/down rotation members are configured on the lower end of the control link and the outer end of the lower arm.

3. The suspension arm device of claim 2, wherein one of the up/down rotation members comprises:
a pair of hinge ends formed integrally while forming a groove into which the outer end of the lower arm is inserted on the lower end of the control link; and
a hinge rod mounted on the outer end of the lower arm to be hinge-coupled with the hinge ends.

4. The suspension arm jointing of claim 2, wherein the other of the up/down rotation members comprises:
a pair of hinge ends formed integrally while forming a groove on the outer end of the lower arm; and
a hinge rod mounted on the lower end of the control link to be hinge-coupled with the hinge ends.

5. The suspension arm device of claim 1, wherein the left/right rotation member is formed by forming an engagement end having an engagement hole integrally on the lower end of the knuckle and burying in the engagement hole a bearing into which the knuckle connection rod of the control link is inserted in a way to rotate.

6. The suspension arm device of claim 5, wherein a nut is engaged with or press-fitted into an upper end of the knuckle connection rod of the control link, the upper end passing through the bearing and protruding from the engagement hole of the engagement end.
